(19) United States
(12) Patent Application Publication
(10) Pub. No.: US 2024/0416271 A1
(43) Pub. Date: Dec. 19, 2024

(54) APPARATUS AND METHOD FOR CAPTURE AND CONCENTRATION OF CARBON DIOXIDE

(71) Applicant: TERRAFIXING INC., Ottawa (CA)

(72) Inventor: Sean Michael Wynn WILSON, Ottawa (CA)

(21) Appl. No.: 18/815,166

(22) Filed: Aug. 26, 2024

Related U.S. Application Data
(63) Continuation-in-part of application No. PCT/CA2023/050241, filed on Feb. 27, 2023.
(60) Provisional application No. 63/314,443, filed on Feb. 27, 2022.

(51) Int. Cl. B01D 53/04; B01D 53/047; B01D 53/26

(52) U.S. Cl. CPC B01D 53/0423; B01D 53/0438; B01D 53/0462; B01D 53/0476; B01D 53/261; B01D 2256/10; B01D 2256/12; B01D 2257/504

(57) ABSTRACT

Apparatus and method for carbon dioxide capture and concentration from air for the production of high-purity carbon dioxide. The apparatus comprises a chamber having a CO₂ adsorbent bed attached to a vacuum source, an input air source, a dryer, and a heater. The apparatus allows for control of the chamber's contents, pressure, and temperature. Adsorbents for capturing CO₂ comprise a zeolite, metal organic framework, covalent organic framework, silica, or alumina. The method provides for: flowing air that has been dried through an adsorbent to capture the CO₂; applying a strong vacuum source, or heat and a strong vacuum source to a capture chamber to remove non-CO₂ components as an exhaust stream; and heating and applying a vacuum source to the adsorbent to extract high purity CO₂.

### CROSS-REFERENCE TO RELATED APPLICATIONS

The present application is a Continuation-in-Part of PCT App. No. PCT/CA2023/050241, entitled “HIGH PURITY CO₂ FROM AIR USING ADSORBENTS” and filed Feb. 27, 2023, which claims priority to U.S. Provisional Pat. App. No. 63/314,443, entitled “HIGH PURITY CO₂ FROM AIR USING ADSORBENTS” and filed Feb. 27, 2022, the disclosures of which are hereby incorporated by reference in their entirety.

### TECHNICAL FIELD

The present invention relates to an apparatus and method for capturing CO₂ from the air. More specifically, the present invention relates to an apparatus and method for capturing carbon dioxide using adsorbents and concentrating same to a high purity.

### BACKGROUND

The continuous increase in the concentration of CO₂ in the atmosphere is well known to contribute to the increase in global surface temperatures. This phenomenon is called global warming and causes many negative changes to the planet. To prevent these negative effects, individuals, companies, and governments have invested time and effort into reducing the amount of CO₂ entering into the atmosphere, as well as removing CO₂ from the atmosphere back to pre-industrialization levels. One way to both mitigate and remove CO₂ emissions is through direct air capture (DAC) with utilization of the captured CO₂.

DAC involves capturing and concentrating CO₂ directly from the air, which reduces the amount of CO₂ in the atmosphere. By removing CO₂ from the atmosphere, the concentration of green-house gases (GHGs) in the atmosphere decreases. A significant reduction of CO₂ from the atmosphere can effectively reverse global warming, if the CO₂ is sequestered. The CO₂ can be sequestered deep within the earth or can be utilized in a product that will hold the CO₂ for a long duration.

Utilizing CO₂ from DAC has many benefits. For instance, CO₂ from DAC can mitigate the GHG impact of an individual, company, or government. As an example, CO₂ is used in many industrial processes. DAC-based mitigation occurs if the industrial user transitions from a traditional fossil fuel-based source of CO₂ (e.g., a by-product of the production of ammonia, hydrogen, or ethylene) to a clean CO₂ source like that produced by DAC.

Utilizing DAC-produced CO₂ is also beneficial because the cost of DAC can be offset by the value of the CO₂ produced, making the whole process more economical. As mentioned above, CO₂ is traditionally produced by a chemical conversion route. However, this is energetically intensive because CO₂ is the most oxidized version of carbon. Further, traditional chemical conversion routes often result in significant impurities.

An alternative method of CO₂ production is to increase the concentration of CO₂ to the point that it becomes inherently more valuable. As the purity of the CO₂ increases, the value of the CO₂ increases. Common grades of CO₂ range from medical, bone dry, beverage, and food grade CO₂ (99.5% and 99.9%) to anaerobic, laser, supercritical fluid, and research grade CO₂ (99.95% and 99.9999%). Capturing CO₂ from the air and concentrating it to these common grades would provide a green source of high-purity CO₂, which would allow individuals, companies, or governments a means to mitigate and remove CO₂.

This high-purity green CO₂ not only has an increased value but will allow many novel CO₂ conversion technology opportunities that were not previously available due to a lack of a green source of high-purity CO₂. This is particularly true with high-purity DAC CO₂ because the high purity allows many novel electrochemical reactions involving CO₂.

Production of high-purity CO₂ using DAC has the additional benefit that, because air is everywhere on Earth, CO₂ captured directly from the air can also be provided everywhere on Earth. In contrast, traditional sources require infrastructure at a fixed location. This is particularly useful for applications where CO₂ production infrastructure does not currently exist, such as in developing countries, remote regions, or disaster-affected areas. Example applications include providing hospitals in such regions with access to reliable, constant CO₂, as CO₂ is commonly used in medical procedures. Providing high-purity CO₂ using DAC has the added benefit that since the CO₂ is produced on site, CO₂ emissions related to transportation will be mitigated.

A challenge associated using DAC to produce high-purity CO₂ is air contains a very dilute stream of CO₂. Air comprises 0.04% CO₂ (i.e., 400 parts CO₂ in one million parts air), but high purity CO₂ typically requires above 99.5%. In higher-purity embodiments, concentrations of CO₂ produced by DAC are at least 99.9999% (i.e., one part non-CO₂ contaminant per million parts CO₂). Air consists of approximately 78.084% N₂, 20.946% 02, 0.9340% Ar, 0.0407% CO₂, 0.000055% H₂, 0.001818% Ne, 0.00018% CH₄, 0.000114% Kr along with lower concentrations of hydrocarbons and CO.

Thus, there is a need for an economical means of capturing and concentrating the CO₂ to a purity of 99.5%, and preferably 99.9999%. No increase in purity to greater than 99.5% pure CO₂ from air concentrations has previously been shown using a single adsorption cycle.

Current DAC methods mainly rely on absorption methods. One such method is used by Carbon Engineering, which utilizes a KOH absorption unit with a calcium carbonate cracker, as exemplified in Keith et al., A Process for Capturing CO2 from the Atmosphere, Joule (2018), https://doi.org/10.1016/j.joule.2018.05.006. Another method is that used by Climeworks, which utilizes amines that are impregnated onto fiber supports, as exemplified in U.S. Pat. No. 10,279,306. A third method is that used by Global Thermostat, which uses amines that are impregnated onto ceramic supports, as exemplified in U.S. Pat. No. 9,908,080. All three of these documents are incorporated herein by reference.

However, these absorption methods alone are not designed for the production of high purity CO₂. For example, DAC technologies that include carbonate crackers, including Carbon Engineering and Heirloom, use natural gas for the heat of the process. However, such carbonate crackers create significant impurities that would be transferred to the product CO₂ stream. Amine-based DAC technologies, including those of Climeworks and Global Thermostat, similarly have major impurity sources that come from the steam used in the process and the oxidative degradation of the amines. These impurities within the product gas stream from absorption-type DAC technologies require additional separation steps, which are costly.

Thus, there is a need for an impurity-free and economical method for capturing carbon dioxide and producing a high-purity carbon dioxide product.

### SUMMARY

This document discloses an apparatus and method for carbon dioxide capture and concentration from air for the production of high-purity carbon dioxide. The apparatus comprises a chamber having a CO₂ adsorbent bed attached to a vacuum source, an input air source, a dryer, and a heater. The apparatus allows for control of the chamber's contents, pressure, and temperature. Adsorbents comprise a zeolite, metal organic framework, covalent organic framework, silica, or alumina. The method provides for: flowing air that has been dried through an adsorbent to capture the CO₂; applying a strong vacuum source, or heat and a strong vacuum source to a capture chamber to remove non-CO₂ components as an exhaust stream; and heating and applying a vacuum source to the adsorbent to extract high purity CO₂.

In a first aspect, this document discloses an apparatus for capturing carbon dioxide, said apparatus comprising: a dryer; a capture chamber, said capture chamber being in fluid communication with said dryer; a CO₂ adsorbent bed, said CO₂ adsorbent bed being positioned within said capture chamber; a vacuum source, said vacuum source being in fluid communication with said CO₂ adsorbent bed; and a heater, said heater being thermally coupled to said CO₂ adsorbent bed such that when said heater is in operation, said heater supplies thermal energy to said CO₂ adsorbent bed, wherein said dryer removes water from an input air stream to thereby produce a pre-capture stream; wherein said capture chamber receives said pre-capture stream from said dryer; wherein said vacuum source causes a pressure in said capture chamber to be below a pressure of said input air stream; wherein at least one of: said pressure and a temperature of said capture chamber is controlled by at least one of: said vacuum source and said heater; wherein said CO₂ adsorbent bed absorbs said carbon dioxide from said pre-capture stream within said capture chamber to thereby produce a purified carbon-dioxide stream, and wherein an exhaust stream is produced from said capture chamber, said exhaust stream having a carbon dioxide concentration lower than that of said input air stream.

The present invention may be implemented such that said CO₂ adsorbent bed comprises at least one of: a zeolite adsorbent, a metal-organic framework adsorbent, a covalent-organic framework adsorbent, a silica adsorbent, or an alumina adsorbent.

The present invention may be implemented such that said dryer is coupled to said vacuum source and wherein said vacuum source regenerates said dryer.

The present invention may be implemented such that at least part of said exhaust stream passes through a second dryer.

The present invention may be implemented such that said apparatus is coupled to a beverage device, wherein said beverage device is configured to use said purified carbon-dioxide stream to perform at least one of: carbonating a beverage or dispensing a drink.

In a second aspect, this document discloses a method for capturing carbon dioxide, comprising: flowing an input air stream through a dryer to thereby produce a pre-capture stream, wherein said dryer removes water from said input air stream; flowing said pre-capture stream into a capture chamber in fluid communication with said dryer, wherein a CO2 adsorbent bed is positioned within said capture chamber; using a vacuum source to thereby decrease a pressure of said capture chamber to a blowdown pressure, thereby removing non-CO2 components from said capture chamber as an exhaust stream; and heating said CO2 adsorbent bed and using said vacuum source on said CO2 adsorbent bed to thereby extract said carbon dioxide from said capture chamber to thereby produce a purified carbon-dioxide stream.

The present invention may be implemented such that step (c) further comprises adding heat energy to said CO₂ adsorbent bed by way of a heater.

The present invention may be implemented such that said heat energy increases a temperature of said CO₂ adsorbent bed to between about a temperature of said input air stream and about 80° C.

The present invention may be implemented as further comprising a step of: (e) passing a dry gas stream through said capture chamber, wherein said dry gas is passed through said CO₂ adsorbent bed to thereby cool said CO₂ adsorbent bed and to thereby form a heated gas stream, and wherein said heated gas stream is flowed through said dryer to thereby regenerate said dryer.

The present invention may be implemented such that said CO₂ adsorbent bed comprises at least one of: a zeolite adsorbent, a metal-organic framework adsorbent, a covalent-organic framework adsorbent, a silica adsorbent, or an alumina adsorbent.

The present invention may be implemented such that said pressure of said capture chamber during step (c) is between 0-0.1 atm.

The present invention may be implemented such that said CO₂ adsorbent bed is heated to a temperature of about 80° C. to about 275° C. during step (c).

The present invention may be implemented such that said method is continuously repeated to extract said carbon dioxide from a continual source of air.

The present invention may be implemented such that said vacuum source is used on said dryer to thereby regenerate said dryer.

The present invention may be implemented as comprising a further step: (e) passing at least part of said exhaust stream through a secondary capture chamber having a secondary CO₂ adsorbent bed, wherein said secondary CO₂ adsorbent bed cools down using said exhaust stream creating a heated exhaust stream.

The present invention may be implemented such that said exhaust stream passes through a separate dryer after being removed from said capture chamber.

The present invention may be implemented as further comprising a step of: (e) executing at least one of: carbonating a beverage or dispensing a drink.

In a third aspect, this document discloses an apparatus for capturing carbon dioxide from air, said apparatus comprising: a first valve controlling a first opening of a major water capture bed enclosure, said first valve being configured to allow an input air stream to introduce said air into said major water capture bed enclosure when said first valve is at least partially open; a major water capture bed positioned within said major water capture bed enclosure; a second valve controlling a boundary between a second opening of said major water capture bed enclosure and a first opening of a capture chamber, wherein said major water capture bed enclosure and said capture chamber are in fluid communication when said second valve is at least partially open; a CO₂ adsorbent bed positioned within said capture chamber; a vacuum source in fluid communication with said capture chamber, wherein said vacuum source is used to create a pressure below atmospheric pressure in said capture chamber; a heater, said heater being thermally coupled to said CO₂ adsorbent bed such that said heater provides heat to said adsorbent bed when said heater is active; a third valve controlling a boundary between a second opening of said capture chamber and a first opening of a minor water capture bed enclosure, wherein said capture chamber and said minor water capture bed enclosure are in fluid communication when said third valve is at least partially open, and wherein said capture chamber is vacuum tight when said second valve and said third valve are closed; a minor water capture bed positioned within said minor water capture bed enclosure; and a fan in fluid communication with a second opening of said minor water capture bed enclosure; wherein said apparatus performs a temperature vacuum swing adsorption cycle to thereby remove said carbon dioxide from said CO₂ adsorbent bed, and wherein CO₂-depleted air is removed by said fan.

The present invention may be implemented such that said CO₂-depleted air is at least partially recycled into said input air stream.

The present invention may be implemented such that said vacuum source regenerates at least one of said major water capture bed and said minor water capture bed.

These and other features of the invention will become more apparent from the following description in which reference is made to the appended drawings.

### BRIEF DESCRIPTION OF THE DRAWINGS

The present invention will now be described by reference to the following figures, in which identical reference numerals refer to identical elements and in which:

FIG. 1 shows a generalized method for capturing and concentrating carbon dioxide from ambient air in accordance with an embodiment of the present invention;

FIG. 2 shows an embodiment of the adsorption step in the method according to FIG. 1;

FIG. 3 shows an embodiment of the blowdown step in the method according to FIG. 1;

FIG. 4 shows a further embodiment of the blowdown step in the method according to FIG. 1;

FIG. 5 shows an embodiment of the evacuation step in the method according to FIG. 1;

FIG. 6 shows an embodiment of the pressurization step in the method according to FIG. 1;

FIG. 7 shows a CO₂ capture and concentration apparatus in accordance with an embodiment of the present invention;

FIG. 8 shows a further embodiment of a CO₂ capture and concentration apparatus;

FIGS. 9A and 9B show a first embodiment where carbon dioxide produced by the apparatus is used to carbonate a beverage;

FIGS. 10A to 10C show a second embodiment where carbon dioxide produced by the apparatus is used to carbonate water;

FIG. 11 shows a Van′t Hoff plot for the four major components of air (i.e., CO₂, N₂, (2, and Ar) on Na-X using Henry's Law Constants calculated from isotherms at temperatures of 22° C., 50° C., 80° C., and 110° C., in accordance with an embodiment of the present invention;

FIG. 12 shows the 3D surface plots of the adsorption capacity of CO₂, N₂, O₂, and Ar on Na-X determined using the TD-Toth model with a CO₂ pressure of 400 ppm or 0.0004 atm, in accordance with an embodiment of the present invention;

FIG. 13 shows the 3D surface plots of the adsorption capacity of CO₂, N₂, and O₂ on Na-X determined using the TD-Toth model along with the TVSA (temperature variable swing adsorption) route during the blowdown step for either a pressure decrease, or a temperature increase with a pressure decrease, in accordance with an embodiment of the present invention;

FIG. 14 shows the flow rates during the blowdown step of a varying duration held at a constant temperature and during an evacuation step (T_{E}=200° C., and t_{E}=120 min) for Na-X, in accordance with an embodiment of the present invention;

FIG. 15 shows the effect of blowdown duration on the blowdown pressure and the purity of the product, in accordance with an embodiment of the present invention;

FIG. 16 shows the flow rates during the blowdown step (constant duration, varying temperature) and evacuation step (T_{E}=200° C., and t_{E}=120 min) for Na-X, in accordance with an embodiment of the present invention; and

FIG. 17 shows the effect of blowdown temperature on the blowdown pressure and the purity of the product produced in accordance with an embodiment of the present invention.

### DETAILED DESCRIPTION

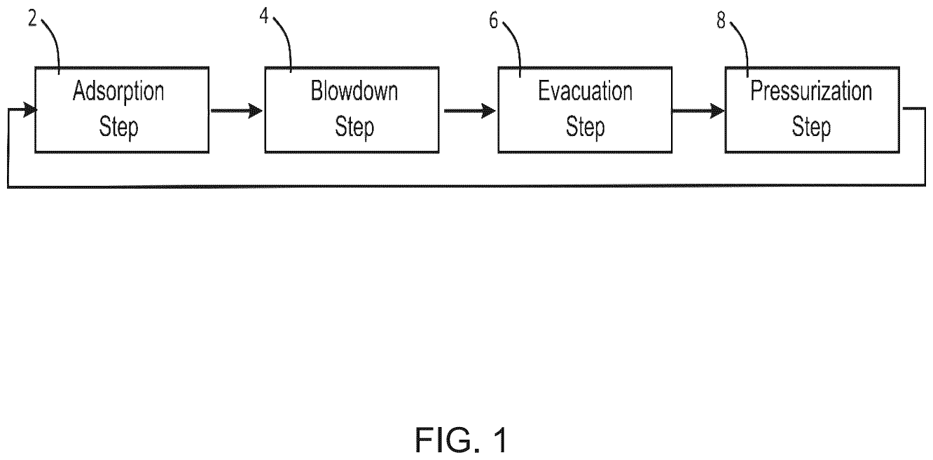

FIG. 1 shows a preferred DAC method to capture CO₂ from ambient air and concentrate it to a high purity, utilizing a temperature vacuum swing adsorption (TVSA) cycle. This method uses dry input air, either from atmospheric conditions or after having been subject to a dryer. Such a dryer may use, for example, condensation, crystallization, desiccation, adsorption, membranes, or other absorption methods to extract atmospheric water. Input air preferably enters in a dried state below a dew point of about −20° C. In a further preferred embodiment, the input air enters in a dried state at a dew point between about −30° C. and about −100° C. In a preferred embodiment, the dryer is regenerated using energy from a heat pump. In a preferred embodiment, the dryer is regenerated using a vacuum.

In a preferred embodiment, the TVSA cycle generally comprises the following steps:
a. an adsorption step 2, where air is flown over an adsorbent which captures the approximately 420 ppm of CO₂ from the dry air at near ambient conditions;
b. a blowdown step 4, which removes the weakly adsorbed non-CO₂ components that are on the adsorbent by applying a strong vacuum, or applying both a strong vacuum and heat;
c. an evacuation step 6, which desorbs the CO₂ that is on the adsorbent by increasing the temperature and applying a vacuum that removes the high-purity CO₂ from the column as a product stream; and
d. a pressurization step 8, which pressurizes the adsorbent to adsorption pressures of the adsorption step 2 with dry air.

After the pressurization step 8, the cycle can be repeated. By repeating the TVSA cycle, further capture and concentration of CO₂ can be achieved from the initial input air.

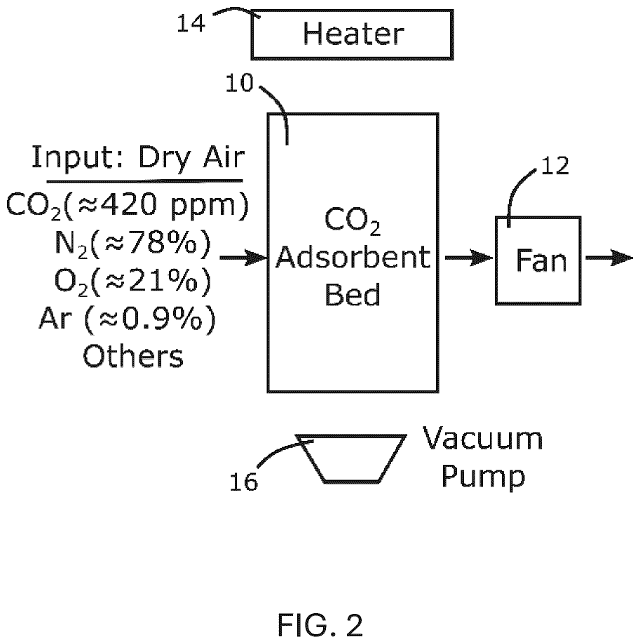

FIG. 2 exemplifies further details of the adsorption step 2 from the TVSA cycle of FIG. 1. The adsorption step 2 flows dry air over the adsorbent in a CO₂ adsorbent bed 10, preferably by using a fan 12 located either upstream or downstream of the CO₂ adsorbent bed 10. This dry input air contains CO₂ concentrations equal to that of ambient conditions of the air's source. The air source may include the atmosphere (having a CO₂ concentration of approximately 420 ppm as of 2021), indoor air within an enclosed space (such as a room within a building), and air exiting a process. If the input air contains pollutants above acceptable limits (based upon either worker safety or component compatibility), such pollutants should be removed prior to this step by using materials such as activated carbons or zeolites, which do not interact significantly with CO₂.

The dry input air flows over the adsorbent which is located in the CO₂ adsorbent bed 10. The CO₂ is captured via adsorption onto the adsorbent's surface. The air flowing over the adsorbent would be at near ambient conditions of temperature and pressure of the input air. In a preferred embodiment, the input air has a temperature between about-80° C. and about 50° C.

In a preferred embodiment, the adsorption step 2 can operate at near-atmospheric pressures, which can be between 30 and 120 kPa, and at CO₂ concentrations between 10 and 10 000 ppm. Air exiting from the CO₂ adsorbent bed 10 would contain significantly less CO₂ than the input air up until the CO₂ adsorbent bed 10 saturates. This occurs when the adsorbent reaches its adsorption capacity at equilibrium conditions with the input air temperature and partial pressure of CO₂ within the air near the exit of the CO₂ adsorbent bed 10. The adsorption step 2 proceeds until the adsorbent bed 10 reaches its target adsorption capacity. In a preferred embodiment, target adsorption capacity is measured from a feedback loop measuring the exiting CO₂ concentration from the CO₂ adsorbent bed 10. In another preferred embodiment, the target adsorption capacity is preconfigured via predictive modelling based upon based the adsorbent's characteristics, and the input air's flow rate and conditions. In a preferred embodiment, the dry CO₂ reduced air that exits the CO₂ adsorbent bed 10 during the adsorption step 2 could be stored and/or redirected into the pressurization step 8 to repressurize the CO₂ adsorbent bed 10 of the same or a separate TVSA cycle. In another preferred embodiment, the dry CO₂ reduced air that exits the CO₂ adsorbent bed 10 during the adsorption step 2 can be stored or redirected into the CO₂ adsorbent bed 10 after the pressurization step 8 and then to the dryer of the same or a separate TVSA cycle.

In a preferred embodiment, the CO₂ adsorbent bed 10 is designed to have a low pressure drop across the bed (in the direction of air flow), and in a preferred embodiment the pressure drop across the CO₂ adsorbent bed 10 would be below 5000 Pa. In a more preferred embodiment, the pressure drop would be below 500 Pa. In a more preferred embodiment, the pressure drop would be below 200 Pa. These low-pressure drops can be achieved by using monolithic adsorbent structures, structured adsorbent packing, or packed beds filled with large pellets with the packed bed having a low length over diameter ratios. To overcome the pressure drop of the CO₂ adsorbent bed 10, forced air flow is required. The air flow may by forced by, e.g., a fan 12, blower, pump, or prevailing wind.

In a preferred embodiment, the ratio of the length of the CO₂ adsorbent bed 10 over the diameter of the CO₂ adsorbent bed 10 is less than 10 for adsorbent pellets between 0.1 mm and 100 mm in diameter. In a more preferred embodiment, the diameter of the adsorbent pellets is 1 mm to 25 mm, with length over diameter ratios less than 2.

The CO₂ adsorbent bed 10 is fully contained within a capture chamber 11, such as a tank or container, and the remaining steps of the method are carried out by altering the pressure, temperature, or air sources within the capture chamber 11. Further, it should be understood that the dimensions of the capture chamber 11 can be selected to best account for the available space and desired output of CO₂ from the system.

In further embodiments, the capture chamber 11 is comprised of a series of tanks or containers linked together. In a further alternative embodiment, the capture chamber 11 comprising the CO₂ adsorbent bed 10 is configured as a cylindrical or square, column or tube (or series of columns or tubes), which optimizes the interaction between the input air and the CO₂ adsorbent material. In a further embodiment, the CO₂ adsorbent bed 10 can be isolated via rotation of a rotating/moving conduit gate valve. In another embodiment, the CO₂ adsorbent bed 10 can be rotated/moved to be isolated. In a further embodiment of the invention, the CO₂ adsorbent bed 10 is designed to minimize the amount of void space when vacuum-tight, to minimize the energy required for vacuum and maximize the purity of the product.

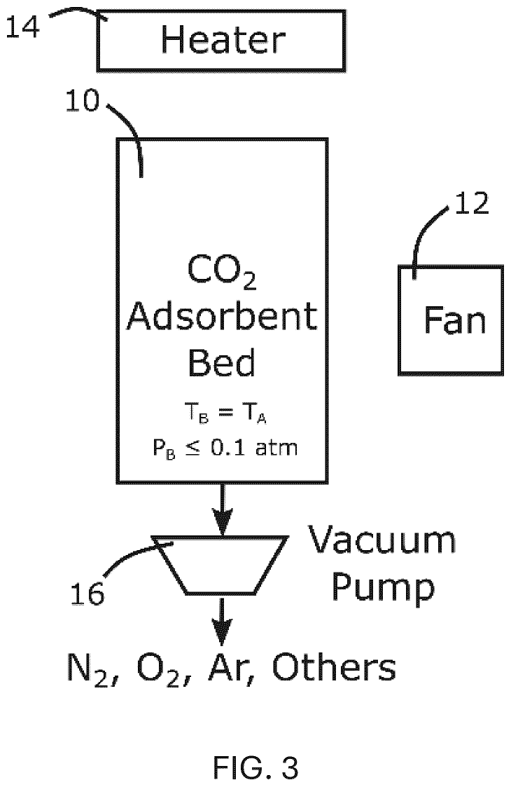

FIG. 3 exemplifies a preferred embodiment of the details of the blowdown step 4, which is initiated once the target adsorption capacity is reached. The blowdown step 4 begins by at least partially isolating the CO₂ adsorbent bed 10 from the input air to reduce the pressure in the capture chamber 11. In a preferred embodiment, this is achieved by isolating the CO₂ adsorbent bed 10 from the fan 12 and input air stream by, e.g., gates, baffles, valves, or physically moving or rotating the CO₂ adsorbent bed 10 out of the input air stream. In a preferred embodiment, the CO₂ adsorbent bed would be isolated so as to minimize the infiltration of gas into the CO₂ adsorbent bed 10, thus avoiding diluting the concentration of the final high purity CO₂ during the blowdown step 4 and the evacuation step 6.

After isolating the CO₂ adsorbent bed 10 from the input air, a vacuum source such as a vacuum pump 16 is connected to the CO₂ adsorbent bed 10. In a preferred embodiment the vacuum pump 16 can comprise a diffusion pump, rotary, reciprocating, or centrifugal vacuum pump. In a preferred embodiment, the vacuum pump 16 is connected to the CO₂ adsorbent bed 10 by a gate, valve, or baffle. The vacuum pump 16 reduces the pressure within the CO₂ adsorbent bed 10 to a blowdown pressure that is below ambient pressure. The degree to which the blowdown pressure is reduced during this step affects the purity of the final CO₂ product stream. A lower blowdown pressure during the blowdown step 4 results in a higher final purity of the CO₂ product stream. In a preferred embodiment, the blowdown pressure 3 is between about 0.00000001 atm and about 0.1 atm pressure.

By reducing the pressure within the CO₂ adsorbent bed 10, the weakly adsorbed components of the input air (predominantly composed of N₂, O₂, and Ar) are removed from the CO₂ adsorbent bed 10 while keeping the majority of the CO₂ on the adsorbent. This exhaust stream is predominantly composed of N₂, O₂, and Ar can then be vented out of the process. In a preferred embodiment, the exhaust stream can be stored in a buffer tank for later use.

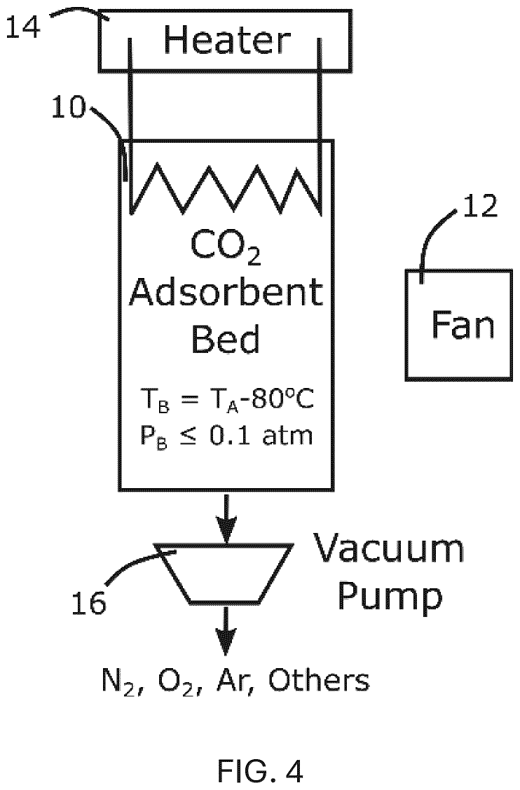

FIG. 4 exemplifies another preferred embodiment of the details of the blowdown step 4. In this embodiment, heating of the CO₂ adsorbent bed 10 is also incorporated into the blowdown step 4. In a preferred embodiment, the heater 14 heats up the CO₂ adsorbent bed relative to the adsorption step 2 temperature, which occurs at near ambient temperature, or at a temperature between about −20° C. and about 80° C. In a preferred embodiment, the CO₂ adsorbent bed 10 is first heated, then a vacuum is applied.

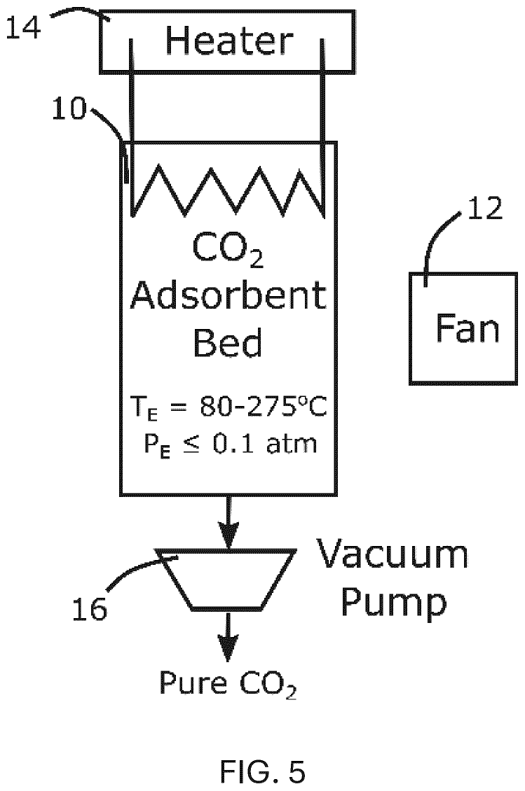

FIG. 5 exemplifies further details of the evacuation step 6. The evacuation step 6 desorbs the CO₂ from the adsorbent by heating up and/or applying a further vacuum to the CO₂ adsorbent bed 10. In a preferred embodiment, the evacuation step 6 activates a heater 14, which is configured to warm the CO₂ adsorption bed 10. Preferably, the CO₂ adsorption bed 10 is warmed to a temperature between about 70° C. and about 300° C. In a more preferred embodiment, the heater heats up the CO₂ adsorbent bed 10 to a temperature between the loading capacity for CO₂ between the adsorption and evacuation temperature, to thereby optimize the productivity and recovery of the system.

The heater 14 can apply heat to the CO₂ adsorbent bed 10 via any acceptable electrical, chemical, conductive, radiative, or heat exchange process. Similarly, any other suitable device or method for heating the CO₂ adsorbent bed 10 may be used. The heater 14 may heat the inner area of the CO₂ adsorbent bed 10 via an immersion heater or heat exchanger, or alternatively heat the exterior or other portion of the capture chamber 11, and thereby conduct, convey, or radiate heat to the CO₂ adsorbent bed 10 to indirectly heat the CO₂ adsorbent material. In a preferred embodiment, the heater 14 utilizes heat from an alternative source, such as utilizing “waste” heat from a separate source to facilitated CO₂ capture. In a preferred embodiment, the CO₂ adsorbent bed 10 is heated using pressurized CO₂ flowing between the heater 14 and CO₂ adsorbent bed 10. In a particularly preferred embodiment, this heated CO₂ is obtained from previous operation of the TVSA cycle.

In a preferred embodiment, a vacuum source is also used to remove the CO₂ from the CO₂ adsorbent bed 10. Once the bed is sufficiently heated, a vacuum pump 16 would be turned on to reduce the pressure within the CO₂ adsorbent bed 10. In a preferred embodiment, the heating of the CO₂ adsorbent bed 10 and the reduction of pressure can occur simultaneously. In a further preferred embodiment, the pressure of the CO₂ adsorbent bed 10 is reduced to between 0 to 0.1 atm, to extract as much of the CO₂ from the CO₂ adsorbent bed 10 as possible. As the evacuation step 6 is occurring, a purified stream of CO₂ exits the vacuum pump 16 and can be collected for further use. In a preferred embodiment, a high-purity CO₂ product stream can be obtained having a CO₂ concentration above 99%, or more preferably above 99.9999%.

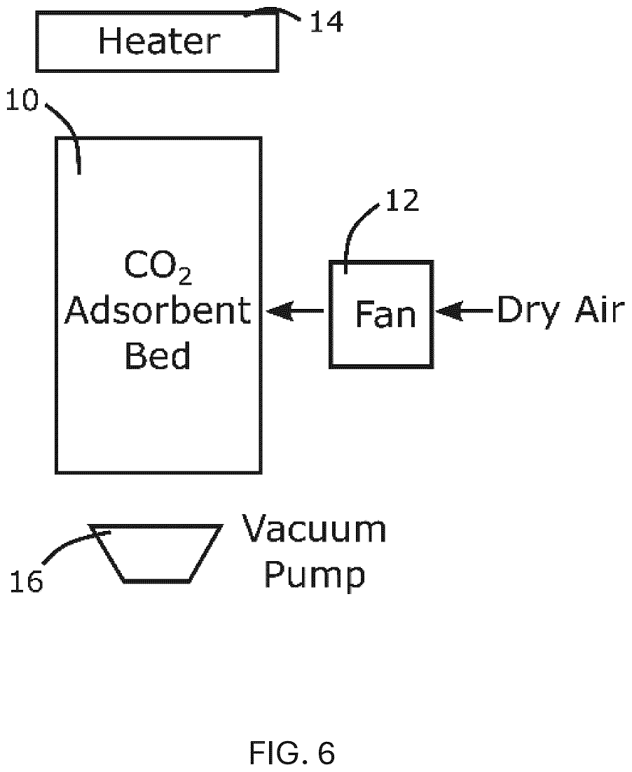

FIG. 6 exemplifies further details of the pressurization step 8. In one embodiment, the vacuum pump 16 and the heater 14 would be disconnected from the CO₂ adsorbent bed 10 and the fan 12 would be connected. Dry air would then be fed in through the fan 12 and used to pressurize the CO₂ adsorbent bed 10 to adsorption pressure of the adsorption step 2, which is at approximately ambient air pressures. In another embodiment, the air can be fed directly to the CO₂ adsorbent bed 10 bypassing the fan 12. In a preferred embodiment, this dry air would come from ambient air that has been dried to a dew point below −60° C., dry air that has been stored from another step of the method, or air that is exiting a parallel method during the adsorption step 2. Once ambient pressures are reached, the cycle is complete and the method can be repeated

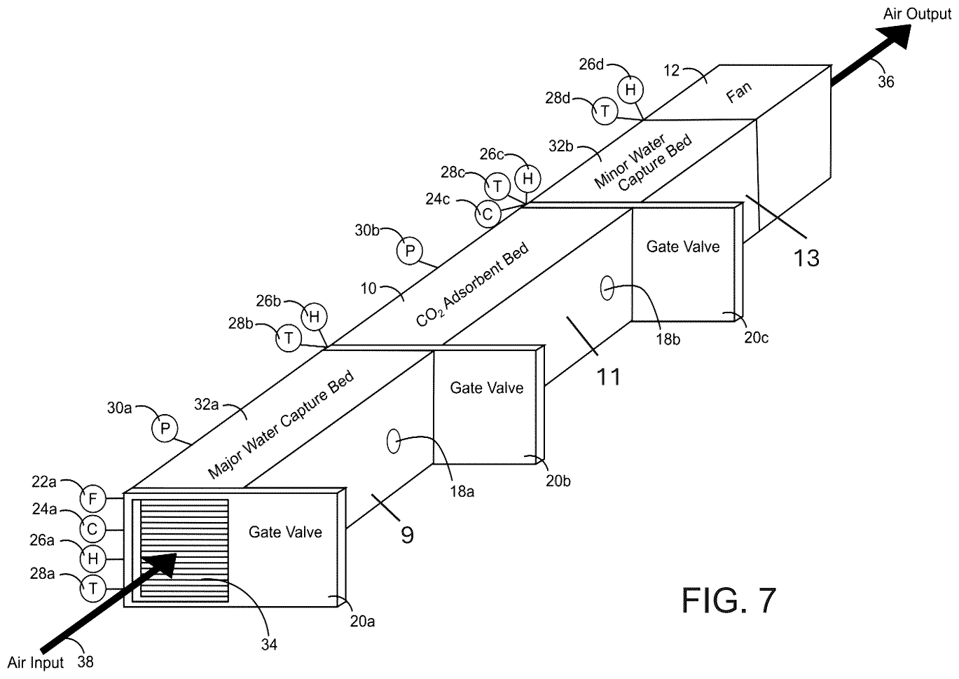

FIG. 7 exemplifies details of an apparatus for capturing CO₂ from the air and concentrating it to high purity CO₂, using the TVSA cycle outlined in FIG. 1 along with an additional waterbed regeneration step. FIG. 7 shows the adsorption step 2 of the process but will cyclically go through all the steps of the TVSA cycle. In an embodiment of the apparatus, the apparatus has a capture chamber 11 containing a CO₂ adsorbent bed 10, a major water capture bed 32a, a minor water capture bed 32b, and a fan 12 in series configuration. Three gate valves 20a, 20b, 20c are used to isolate the major water capture bed 32a and the CO₂ adsorbent bed 10, allowing for a vacuum-tight seal. There is one vacuum port 18a on the major water capture bed enclosure 9, which allows the major water capture bed 32a to be connected to a vacuum pump 16 via, e.g., gates, baffles, or valves. There is another vacuum port 18b on the capture chamber 11 containing the CO₂ adsorbent bed 10 which allows the CO₂ adsorbent bed 10 to be connected to the same or separate vacuum pump 16 via, e.g., gates, baffles, or valves. In one embodiment, the major water capture bed 32a comprises a structured desiccant bed 34. In a preferred embodiment, the structured desiccant bed 34 comprises an adsorbent based material including but not limited to a zeolite, activated carbon, silica, alumina, covalent organic framework (COF), or metal organic framework (MOF). In one embodiment, the CO₂ adsorbent bed 10 is a structured CO₂ adsorbent bed. In a preferred embodiment, the structured CO₂ adsorbent bed comprises an adsorbent based material including but not limited to a zeolite, activated carbon, silica, alumina, COF, or MOF. In one embodiment, the minor water capture bed 32b comprises a structured desiccant bed of the same or different type as the major water capture bed 32a. At the air input 38 before the major water capture bed 32a, there is a temperature sensor 28a, a humidity sensor 26a, a CO₂ concentration sensor 24a, and a flow sensor 22a. Attached to the major water capture bed enclosure 9, there is a pressure gauge 30a to determine the pressure of the major water capture bed 32a. After the major water capture bed 32a and before the CO₂ adsorbent bed 10, there are a temperature sensor 28b and a humidity sensor 26b. Attached to the CO₂ adsorbent bed enclosure there is a pressure gauge 30b to determine the pressure in the CO₂ adsorbent bed 10. Between the CO₂ adsorbent bed 10 and the minor water capture bed 32b, there are a CO₂ concentration sensor 24c, a temperature sensor 28c, and a humidity sensor 26c. After the minor water capture bed 32b, there are a temperature sensor 28d and a humidity sensor 26d. As can be seen, the apparatus shown in FIG. 7 is simple and requires only one CO₂ adsorbent bed 10 to capture CO₂ from the air and to concentrate it to form high-purity CO₂.

In one embodiment, during the adsorption step 2 of the process, the air enters the process and its temperature, humidity, CO₂ concentration, and flow rate are measured prior to entering the major water capture bed 32a. The air then has its humidity removed from the major water capture bed 32a which produces a dry air stream. The dry air stream's temperature and humidity is then measured. The dry air then enters the CO₂ adsorbent bed 10 where the CO₂ is adsorbed onto the structured CO₂ adsorbent, thus producing a dry CO₂-reduced air stream. The dry CO₂-reduced air stream then has its CO₂ concentration, temperature and humidity measured. The dry CO₂ reduced air stream then flows over the minor water capture bed 32b, allowing the minor water capture bed 32b to be regenerated and release water to produce a somewhat dry CO₂ reduced air stream. The somewhat dry CO₂ reduced air stream then has its temperature and humidity measured, and then exits out the fan 12. The fan 12 produces a forced convection through the apparatus.

In one embodiment, the use of the temperature sensors 28a, 28b, 28c, 28d, humidity sensors 26a, 26b, 26c, 26d, CO₂ concentration sensors 24a, 24c, and flow sensor 22a, allows for the calculation of the predictive performance of the major water capture bed 32a, the CO₂ adsorbent bed 10, and the minor water capture bed 32b during the adsorption step, as well as a feed-back loop to maximize the performance of the apparatus.

In one embodiment, during the blowdown step 4 of the method, the gate valve closes. This creates a vacuum tight seal, isolating the CO₂ adsorbent bed 10 from the major water capture bed 32a, and the minor water capture bed 32b. This then allows for the vacuum pump 16 to reduce the pressure within the CO₂ adsorbent bed 10, removing the non-CO₂ components from the bed. The non-CO₂ components form an exhaust stream that exit the process. The pressure within the CO₂ adsorbent bed 10 is measured using the pressure sensor 30 connected to the capture chamber 11. If heat and vacuum are used to remove the non-CO₂ components, a heater, which is not depicted in FIG. 7, would add energy to the CO₂ adsorbent bed 10, helping aid the desorption of non-CO₂ components. One of the temperature sensors 28b, 28c is used to determine the temperature of the CO₂ adsorbent bed 10 during the blowdown step 4. The use of the pressure sensor 30b and the temperature sensor 28b, 28c also controls the heater 14 and the vacuum pump 16 during the evacuation step 6. After the evacuation step 6, the pressurization step 8 begins by opening the gate valve 20c between the CO₂ adsorbent bed 10 and the minor water capture bed 32b, which is contained within the minor water capture bed enclosure 13. This allows for the flow of ambient air through the fan 12, then through the minor water capture bed 32b to create a dry air stream. The dry air stream then flows into the CO₂ adsorbent bed 10.

In one embodiment, after the pressurization step 8, the waterbed regeneration step begins by opening all the gate valves 20a, 20b. Next, by flowing air from the fan 12 through the minor water capture bed 32b to create a dry air steam, and then flowing the dry air stream through the CO₂ adsorbent bed 10 to cool the CO₂ adsorbent bed 10, and to create a dry warm air stream. The dry warm air stream would then flow through the major water capture bed 32a, aiding in the regeneration of the major water capture bed 32a. After the major water capture bed 32a has been regenerated, the cycle can be repeated with the adsorption step 2.

In one embodiment, the major water capture bed 32a is significantly larger than the minor water capture bed 32b. The sizing of the major water capture bed 32a is determined based on the amount of water that needs to be removed during the adsorption step 2 of the process and the adsorbent(s) that comprise the major water capture bed 32a. The sizing of the minor water capture bed 32b is determined by the amount of water that needs to be removed during the pressurization step 8 and the waterbed regeneration step and the adsorbent(s) that comprise the minor water capture bed 32b.

In one embodiment, a vacuum is used during the blowdown step 4 on the major water capture bed 32a to aid in regeneration. The vacuum can be created from the same or separate vacuum pump as that of the vacuum pump 16 that is acting on the CO₂ adsorbent bed 10.

In one embodiment, heat is applied to the major water capture bed 32a to aid in the regeneration of the bed. In another embodiment, heat is applied to the minor water capture bed 32b to aid in the regeneration of the bed. In another embodiment, a heat pump would connect the major water capture bed 32a to the minor water capture bed 32b, allowing for energy to be transferred from the water capture bed that is desiccating to the water capture bed that is regenerating.

A wide variety of adsorbents, including those previously deemed unsuitable for use in the capture and concentration of CO₂, may be suitable for use in accordance with this invention. Preferably, the adsorbent chosen for the CO₂ adsorbent bed 10 has at least an adsorption capacity for CO₂ greater than 0.1 mmolCO₂/g of adsorbent, and more preferably greater than 5.0 mmolCO₂/g of adsorbent, at conditions of 20° C. and partial pressures of 0.0004 atm of CO₂.

In another preferred embodiment the preferred CO₂ adsorbent has a surface area greater than 100 m²/g. In a further preferred embodiment, the CO₂ adsorbent has a pore structure that allows CO₂ to diffuse through its structure.

In another preferred embodiment the adsorbent has an average heat of adsorption of CO₂ that is between about 25 KJ/mol and about 100 KJ/mol.

The heat of adsorption is important with regards to the energy required to desorb the CO₂ with larger heats of adsorption requiring more energy for desorption of the CO₂. The profile of the heat of adsorption with respects to loading, which can be seen in a Clausius-Clapeyron relationship, is also important. This relationship shows that the initial CO₂ that is adsorbed releases more energy than subsequent CO₂ adsorbed. Thus, the initial CO₂ adsorbed would require more energy to desorb than subsequently adsorbed CO₂ molecules. In a particularly preferred embodiment, the heat of adsorption of CO₂ on the adsorbent would be as low as possible and constant over a range of loadings.

One beneficial aspect of the invention is that adsorbents that are commonly considered to be water unstable, or otherwise preferentially adsorb water over CO₂, can be used to capture and concentrate CO₂ due to the water removal prior to the separation of CO₂. This allows many adsorbents, such as aluminas, zeolites, covalent organic frameworks (COF), and MOFs, to be used for DAC, contrary to previously accepted practices.

In a preferred embodiment, the CO₂ adsorbent bed 10 is made up of zeolites having oxygen tetrahedral frameworks incorporating Si, Al, P, Ge, B, Mg, Zn, Ga, Co, or Be, (including the presence of two or more differing structures, or mixtures of different structures). In an alternatively preferred embodiment, the CO₂ adsorbent bed 10 is made up of mixtures of CO₂ adsorbent materials having non framework species, or mixtures of framework and non-framework species.

In a further preferred embodiment, the zeolite frameworks include, but are not limited to, Linde Type A, faujasite, or chabazite, which all have large CO₂ adsorption capacities at low CO₂ partial pressures, but which adsorb water competitively over CO₂. Faujasite structured zeolites, and in particular faujasite structured zeolites with a Si/Al ratio of below 2, are particularly preferable adsorbents for this separation.

Preferred zeolites can have a variety of counterbalancing cations in the metals group within them, such as alkali or alkaline earth metals, which change the strength of interaction with CO₂ and therefore the heat of adsorption of CO₂. In a preferred embodiment, MOF's including, but not limited to, NbOFFIVE-1-Ni, SGU-29, Mg-MOF-74, SIFSIX-3-Cu, SIFSIX-2-Cu, Mg-dobpdc-mmen are also preferred adsorbents for this separation.

In a preferred embodiment, the CO₂ adsorbent bed 10 can be composed of one or more types of adsorbents. In a further preferred embodiment, the adsorbents can be arranged according to the flow of input air to first expose the air to an adsorbent with a weaker CO₂ interaction, then to an adsorbent with a stronger CO₂ interaction. In a further preferred embodiment, the same adsorbent in two configurations can be layered according to the direction of the flow. These two configurations can be a pellet/structure/packing with a higher pellet/structure/packing diffusion resistance, and a lower pellet/structure/packing diffusion resistance. These would be oriented with regard to the flow of air so as to first contact the adsorbent with the higher pellet/structure/packing diffusion resistance, and then contact the adsorbent with the lower pellet/structure/packing diffusion resistance.

In a preferred embodiment, this apparatus and method can be combined with a process that produces a dry (or partially dry) air stream that still has some CO₂ within it. This would allow for this method to use less energy by requiring less water to be removed from the air prior to separating the CO₂ from the air. This method can be placed after the dryer without affecting the desired properties of the dried air for most applications.

A benefit of the invention is that this method produces safer high purity CO₂. With traditional sources of CO₂, the production of CO₂ is a by-product of the production of ammonia, hydrogen, or ethylene. These sources generate CO₂ with a significantly higher concentration of dangerous pollutants (e.g., residual hydrocarbons). This allows high-purity CO₂ from air to be inherently safer than that from more traditional sources.

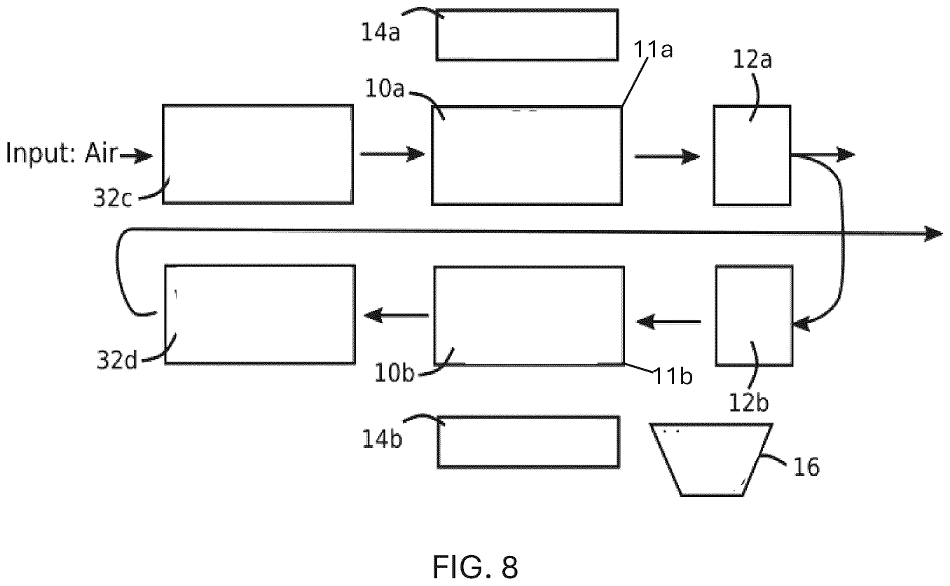

In a further embodiment shown in FIG. 8, multiple water capture beds and CO₂ adsorbent beds 10 can be combined. In such an embodiment, an input air stream first flows into a pre-capture water capture bed 32c, where the input air stream is dried to form a pre-capture stream. The pre-capture stream then flows into a primary capture chamber 11a having a primary CO₂ adsorbent bed 10a, which is thermally coupled with a primary heater 14a. As with the previous embodiment, the primary capture chamber 11a is connected to a vacuum pump 16. Carbon dioxide is thus captured and primary exhaust stream is produced that is at least partially depleted of carbon dioxide. It should be understood that the mechanism of carbon capture operates similarly to that previously discussed herein.

In the embodiment of FIG. 8, the exhaust stream is circulated by a primary fan 12a. However, in this embodiment, at least part of the exhaust stream is recycled into a secondary capture chamber 11b having a secondary CO₂ adsorbent bed 10b. This would happen when the secondary CO₂ adsorbent bed 10b is hot, due to the heat transfer during the evacuation step. This waterbed regeneration step will cool the secondary CO₂ adsorbent bed 10b while regenerating the secondary pre-capture water capture bed 32d. It should be clear that in this embodiment that some of the primary exhaust stream may be fully removed from the apparatus or the entire primary exhaust stream can be recycled. The flow of the recycled exhaust stream can be forced using primary fan 12a, secondary fan 12b, or a tertiary fan that is not depicted. The flow of the recycled exhaust stream through the secondary CO₂ adsorbent bed 10b cools down the secondary CO₂ adsorbent bed 10b. A secondary heater 14b and the vacuum pump 16 are also connected to the secondary capture chamber 11b. Again, the mechanism of carbon capture operates similarly to that previously discussed herein.

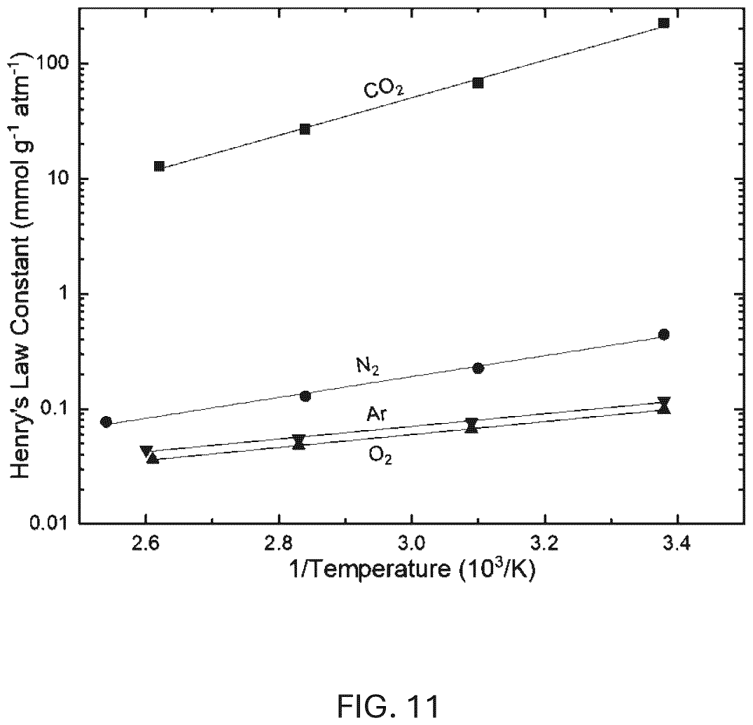

A further benefit of the present invention is that the method according to one embodiment of the invention takes advantage of the equilibrium adsorption capacities of the adsorbent. Specifically, the method takes advantage of the stronger affinity of CO₂ for the surface of the adsorbent compared to the other major components in air during the blowdown step 4. This affinity is illustrated in FIG. 11, which depicts a Van′t Hoff plot including CO₂, N₂, O₂, and Ar calculated from pure gas adsorption isotherms taken from a sample of Na-X. This plot depicts the stronger Henry's Law Constants (slope of the isotherm as partial pressure approaches 0) of CO₂, which is greater than two orders of magnitude higher than that of N₂, O₂, and Ar. This difference allows for the production of high purity CO₂ up to 99.9999%.

This major difference in interaction is due to the stronger van der Waals forces between the CO₂ and Na-X, compared to that of N₂, O₂, and Ar. This relationship holds true for most physisorbent type adsorbents, due to the polarizability and quadrupole moment of CO₂ being greater than N₂, O₂, and Ar, each having a polarizability of 2.65, 1.76, 1.60, and 1.64 Å³, respectively, and a quadrupole moment of 4.3, 1.52, 0.39, and 0 Å², respectively). With CO₂'s higher polarizability and quadrupole moment, an adsorbent's surface with more significant interaction with CO₂ over N₂, O₂, and Ar will be able to be purify CO₂. The more significant the interaction between CO₂ over N₂, O₂, and Ar, the greater potential to purify higher purities of CO₂.

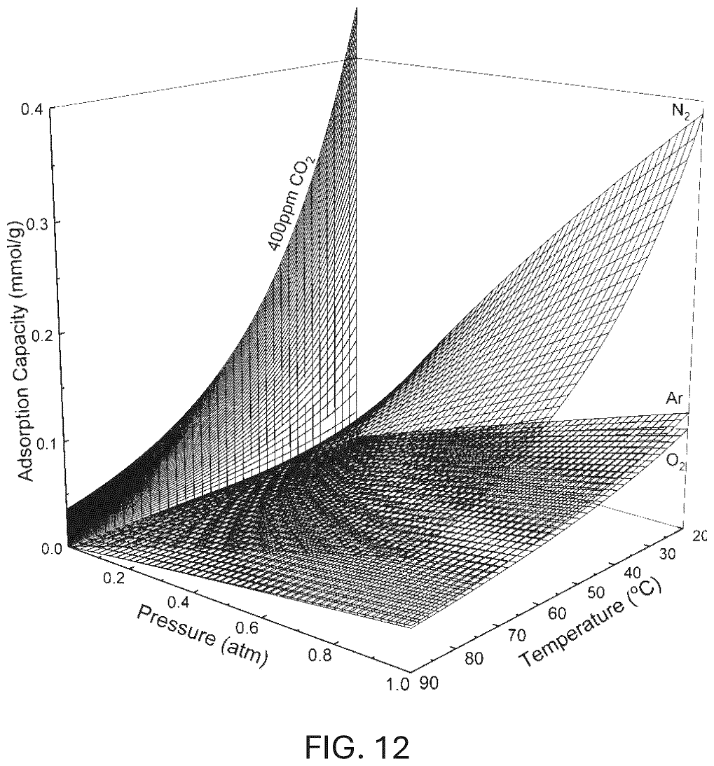

To demonstrate this benefit of this process, the temperature dependant Toth (TD-Toth) model can be used which is shown in FIG. 12. This 3D surface plot shows the adsorption capacity of CO₂, N₂, O₂, and Ar on Na-X calculated from the TD-Toth model which was calculated from pure gas adsorption isotherms. FIG. 12 shows how the changing conditions impact the TVSA cycle. For example, the adsorption step 2 occurring at approximately 20° C. and 1 atm with input air composed of 78.09% nitrogen, 20.95% oxygen, 0.93% argon, and 0.04% carbon dioxide, Na-X would adsorb 0.45 mmol/g of CO₂, 0.32 mmol/g of N₂, 0.02 mmol/g of Oz, and a very small amount of Ar adsorbed.

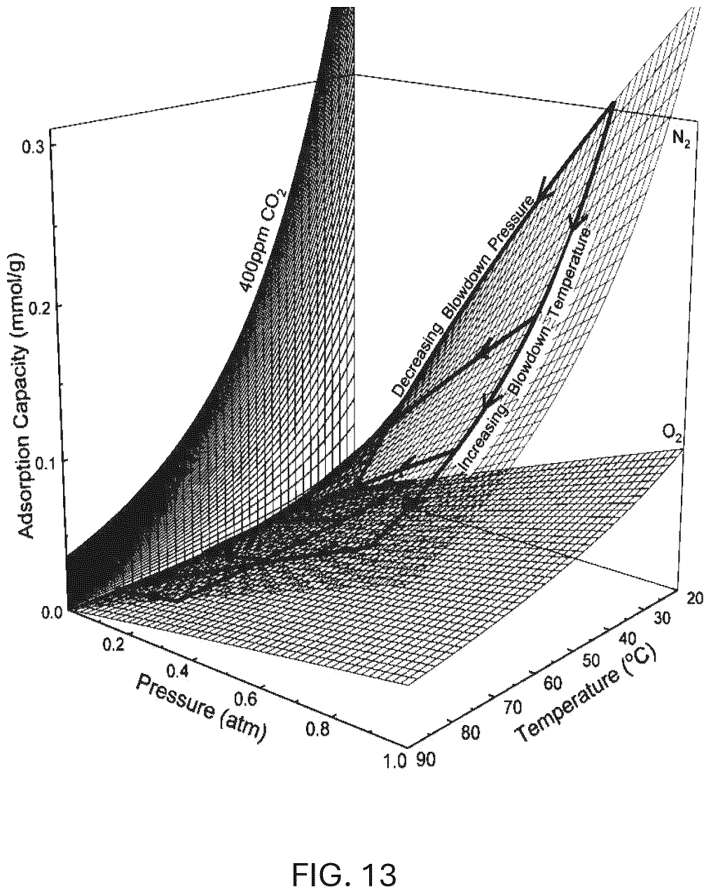

Further, to obtain a high-purity CO₂ product, the method includes the ability to remove the N₂, O₂, and Ar adsorbed onto the adsorbent. To achieve this, two preferred embodiments of this invention can be taken and is shown in FIG. 13. Starting from the top right point on the plane for N₂ which equates to 20° C. 78.09% nitrogen at 1 atm, and the plane for O₂ which equates to 20° C. 20.95% oxygen at 1 atm, a vacuum can be applied to the CO₂ adsorbent bed 10, which was outlined in the blowdown step 4 of FIG. 3. This vacuum will decrease the partial pressure thereby creating a new equilibrium between the gas and the adsorbent. The adsorbent from this new equilibrium will desorb N₂ and (2, releasing them into the gas phase and allowed to be carried out of the CO₂ adsorbent bed 10. This is illustrated in FIG. 13 by the line labeled decreasing blowdown pressure. This decreasing blowdown pressure removes N₂, O₂, and Ar but not CO₂ because of CO₂'s high Henry's Law constant compared to N₂, O₂, and Ar as shown in FIG. 11.

Further, a vacuum and heat can be applied to the CO₂ adsorbent bed 10 which was outlined in the blowdown step 4 of FIG. 4Error! Reference source not found. By applying heat, the equilibrium is shifted to warmer temperatures, which is denoted by increasing blowdown temperature in FIG. 13. This increase in temperature, in combination with vacuum shifting the equilibrium to lower pressure, will aid in the removal of N₂, O₂, and Ar from the adsorbent. The benefit of using heat and vacuum during the blowdown step 4 is that not as strong of a vacuum is required for a particular purity of CO₂ product.

Additionally, the apparatus can be directly or indirectly coupled to a device that uses the captured and concentrated CO₂ produced by the apparatus. For example, such a device may comprise a beverage carbonating device, a drink dispenser, a medical device, or industrial equipment.

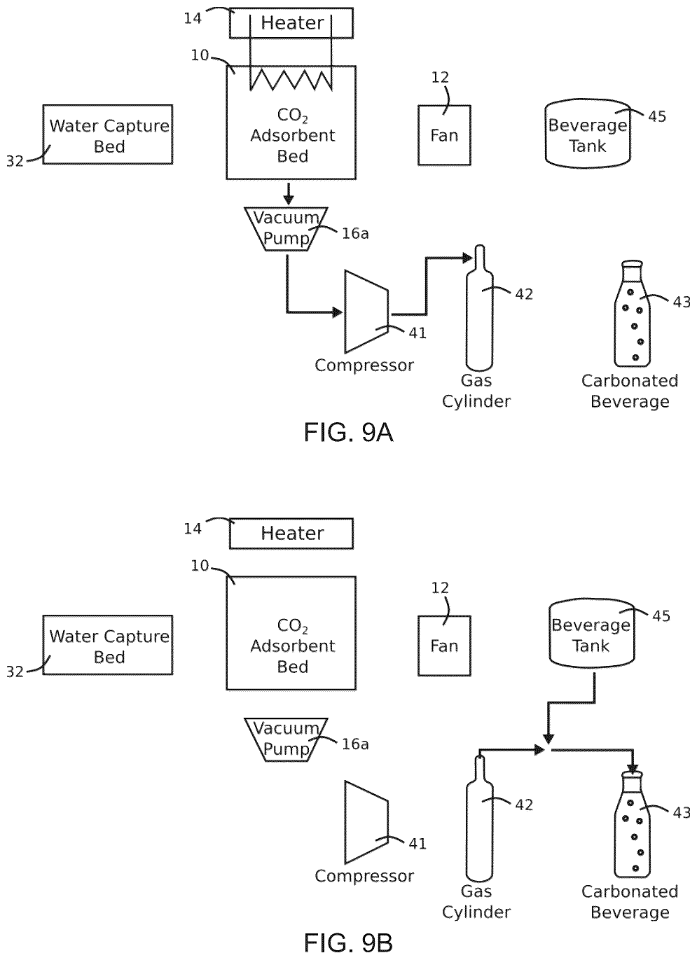

FIGS. 9A and 9B show a first embodiment where carbon dioxide captured by the apparatus is used to carbonate a beverage. In FIG. 9A, carbon dioxide removed by the vacuum pump 16a is compressed using a compressor 41 and stored in a gas cylinder 42. In FIG. 9B, a beverage in a beverage tank 45 is carbonated using carbon dioxide released from the gas cylinder 42, thus creating a carbonated beverage 43

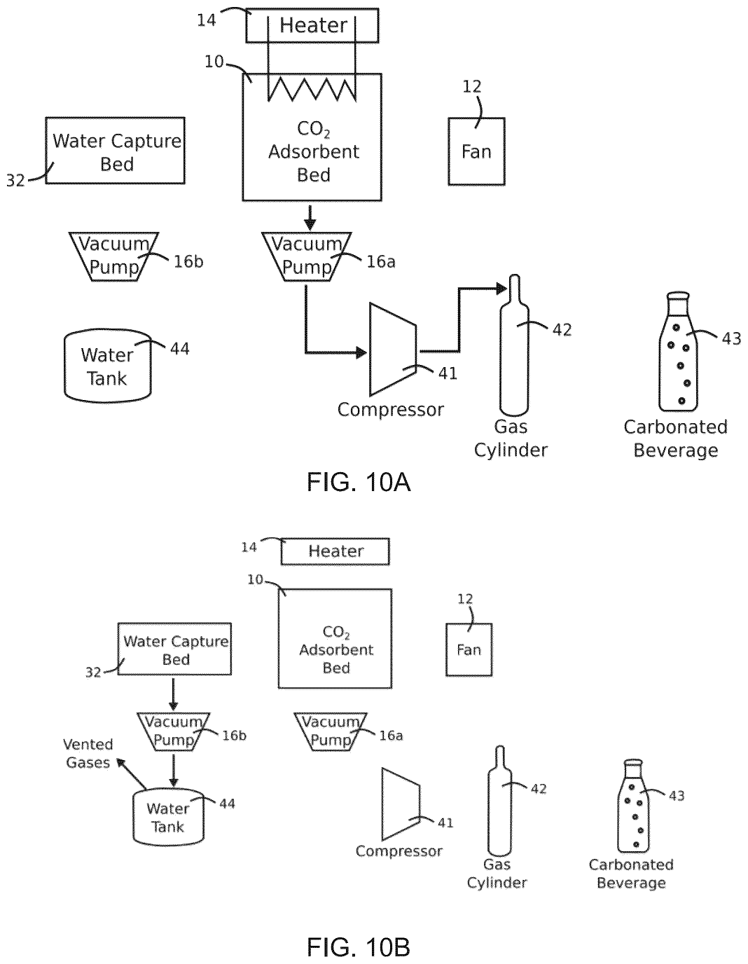

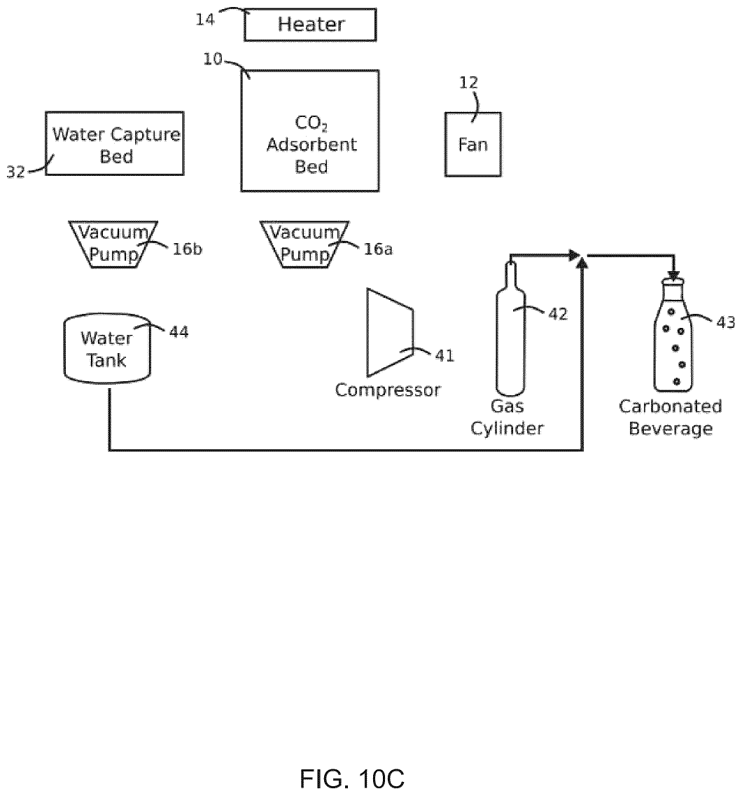

FIGS. 10A to 10C show a second embodiment where carbon dioxide captured by the apparatus is used to carbonate a beverage. As in FIG. 9A, FIG. 10A shows carbon dioxide being removed by the vacuum pump 16a, compressed using a compressor 41, and stored in a gas cylinder 42.

FIG. 10B shows water being removed from the water capture bed 32 using a vacuum pump 16b and stored in a water tank 44. Gases are vented from the water tank 44.

FIG. 10C shows the combination of the water from the water tank 44 and the carbon dioxide stored in the gas cylinder 42, thus producing a carbonated beverage 43. This embodiment has the advantage of supplying both water and carbon dioxide, thus producing a carbonated beverage 43 without any external water or carbon dioxide.

It should be understood that the beverage carbonating device can vary. For example, a home countertop water-carbonating device may be used. In another embodiment, a fast food-style soda fountain may be used. Additionally, or alternatively, carbon dioxide can be used to generate pressure to dispense a drink (e.g., using a beer keg).

### Example 1

The embodiment exemplified by FIGS. 1 to 6 was experimentally tested to highlight the advantages of this method, such as production of high purity CO₂ from air using adsorbents in a single TVSA cycle.

Na-X, a low Si/Al ratio faujasite structured zeolite with Na⁺ as a cation, was used as the adsorbent in the CO₂ adsorbent bed 10 for the TVSA cycle. The adsorption step 2 was kept constant throughout the experiments at 20° C. with 2500 sccm of dry air flowing through the CO₂ adsorption bed 10 until the Na-X reached saturation. The evacuation step 6 was kept constant at 200° C. for a duration of 120 min while applying a vacuum to the system. The pressurization step 8 was kept constant by pressurizing the CO₂ adsorbent bed 10 rapidly over the course to approximately 10 seconds till the pressure reached 1 atm with dry air.

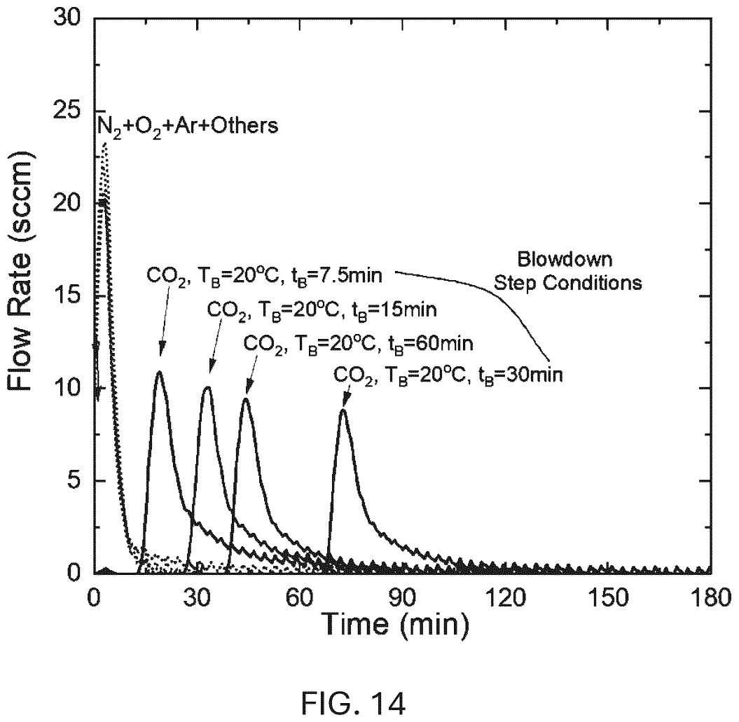

The blowdown step 4 was varied between the experiments, with four blowdown durations of 7.5 min, 15 min, 30 min, and 60 min tested at a blowdown temperature of 20° C. By varying the blowdown duration, different blowdown vacuum pressures can be tested, with longer durations equating to lower pressures. The exiting flowrate from the blowdown step 4 and the evacuation step 6 are shown for these experiments in FIG. 14. The dotted line represents the flow rates of N₂, O₂, and Ar, and the solid line represents the flow rates of CO₂. A second order Savitzky-Golay technique was used to smooth the lines due to analysis of the gas stream. For all blowdown durations, the majority of N₂, O₂, and Ar leave the CO₂ adsorbent bed 10 during the blowdown step 4, with the majority of CO₂ leaving the CO₂ adsorbent bed 10 during the evacuation step 6. This shows that applying just a vacuum removes non-CO₂ components with minimal removal of CO₂. For longer durations which equate to deeper vacuums, the size of the CO₂ peak decreases. This decrease indicates that CO₂ is lost by applying stronger vacuums. An embodiment of this invention includes recouping this dry CO₂ by feeding it into the adsorption step 2.

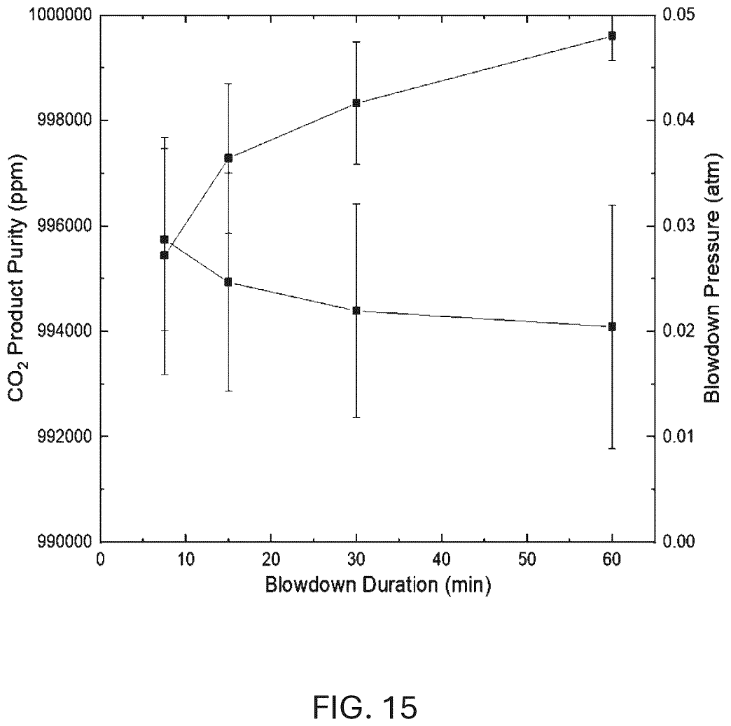

FIG. 15 shows the blowdown duration shown on the x-axis, purity in ppm shown on the left y-axis, and blowdown pressure on the right y-axis. By increasing the duration of the blowdown step 4, the pressure in the column was decreased, and the purity of the product was increased. With a blowdown duration of 7.5 min at 20° C., a product purity of 99.54+0.23% CO₂ was acquired meeting the lowest high purity grade of 99.5% CO₂. As the blowdown duration increased from 15 min to 30 min, to 60 min, the purity increased from 99.73+0.14% to 99.83+0.12% to 99.96+0.05%, respectively. This increase in CO₂ purity meets the requirements for anaerobic, laser, and supercritical fluid grade CO₂, while being within the margin of error of research grade CO₂. The required evaluating equipment of thermocouples and pressure gauges added roughly 7.1 cm³ of void space, and 11.4 cm³ of void space due to the void fraction of the pellets. This cumulative void space of 18.5 cm³ would have reduced the measured purity, therefore, for the highest purity CO₂, it is recommended to reduce the void space as much as possible.

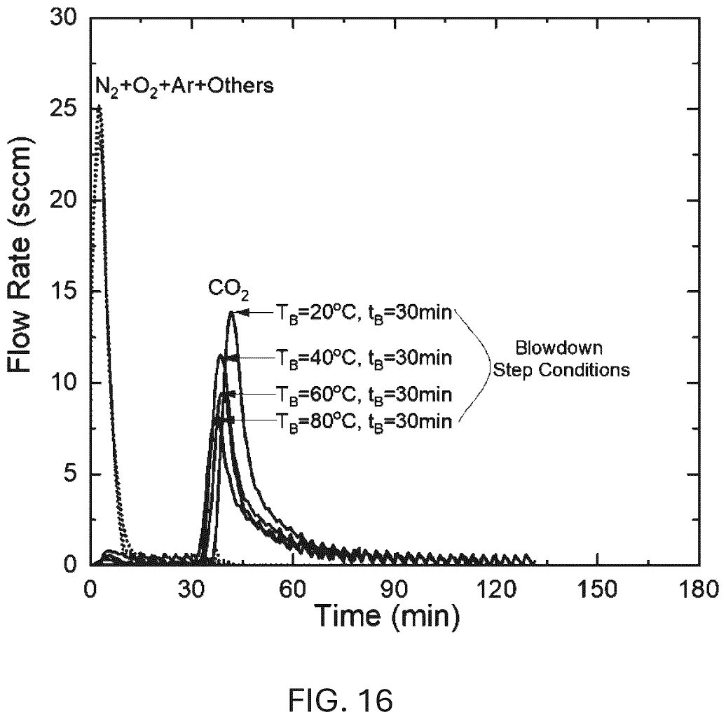

The blowdown step 4 was also varied between the experiments, with four blowdown temperatures of 20° C., 40° C., 60° C., and 80° C. and a blowdown duration of 30 min. The exiting flowrate from the blowdown step 4 and the evacuation step 6 are shown for these experiments in FIG. 16. With all blowdown durations being 30 min, all peaks are stacked on-top of each other. Similarly, to varying the blowdown duration, N₂, O₂, and Ar exit the column noticeably during the blowdown step 4. However, a small amount of CO₂ also exits the CO₂ adsorbent bed 10 with the warmer temperatures having a more noticeable amount. This effect of more CO₂ being lost at warmer blowdown temperatures during the blowdown step 4 can also be observed in the evacuation step 6 with the warmer blowdown temperatures having a smaller CO₂ flow rate exiting during evacuation step 6.

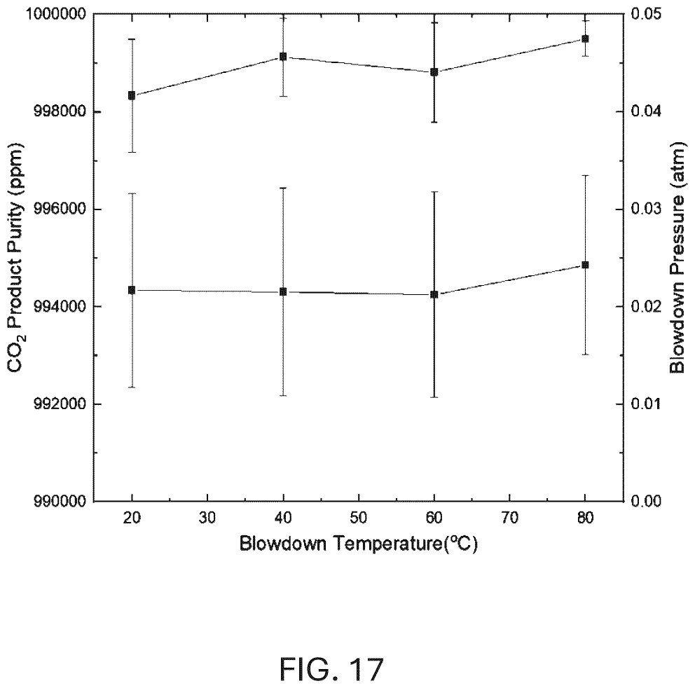

FIG. 17 shows the blowdown temperature on the x-axis, purity in ppm on the left y-axis, and blowdown pressure on the right y-axis. By elevating the blowdown temperature of the blowdown step 4 from 20° C. to 80° C., the purity of the product increased from 99.83+0.12% to 99.95+0.04%, which can be seen from FIG. 17. This increase in purity was not due to the decrease in pressure, which was observed by changing the blowdown duration, but by elevating the temperature. This can be seen from the near constant blowdown pressure, with only a slight increase in blowdown pressure for a blowdown temperature of 80° C.

All references and publication referred to herein are hereby incorporated by reference in their entirety.

The expression “at least one of X and Y”, as used herein, means and should be construed as meaning “X, or Y, or both X and Y”.

The expressions “about” and “approximately”, as used herein when referring to a numerical value, mean and should be construed as meaning a range formed by that value, plus or minus 10%. For example, “about 100° C.” should be construed as “100° C.±10° C.”, that is, “90° C. to 110° C.”.

A person understanding this invention may now conceive of alternative structures and embodiments or variations of the above, all of which are intended to fall within the scope of the invention as defined in the claims that follow.

We claim:

1. An apparatus for capturing carbon dioxide, said apparatus comprising:
a dryer;
a capture chamber, said capture chamber being in fluid communication with said dryer;
a CO₂ adsorbent bed, said CO₂ adsorbent bed being positioned within said capture chamber;
a vacuum source, said vacuum source being in fluid communication with said CO₂ adsorbent bed; and
a heater, said heater being thermally coupled to said CO₂ adsorbent bed such that when said heater is in operation, said heater supplies thermal energy to said CO₂ adsorbent bed,
wherein said dryer removes water from an input air stream to thereby produce a pre-capture stream;
wherein said capture chamber receives said pre-capture stream from said dryer;
wherein said vacuum source causes a pressure in said capture chamber to be below a pressure of said input air stream;
wherein at least one of: said pressure and a temperature of said capture chamber is controlled by at least one of: said vacuum source and said heater;
wherein said CO₂ adsorbent bed absorbs said carbon dioxide from said pre-capture stream within said capture chamber to thereby produce a purified carbon-dioxide stream, and
wherein an exhaust stream is produced from said capture chamber, said exhaust stream having a carbon dioxide concentration lower than that of said input air stream.

2. The apparatus according to claim 1, wherein said CO₂ adsorbent bed comprises at least one of: a zeolite adsorbent, a metal-organic framework adsorbent, a covalent-organic framework adsorbent, a silica adsorbent, or an alumina adsorbent.

3. The apparatus according to claim 1, wherein said dryer is coupled to said vacuum source and wherein said vacuum source regenerates said dryer.

4. The apparatus according to claim 1, wherein at least part of said exhaust stream passes through a second dryer.

5. The apparatus according to claim 1, wherein said apparatus is coupled to a beverage device, wherein said beverage device is configured to use said purified carbon-dioxide stream to perform at least one of: carbonating a beverage or dispensing a drink.

6. A method for capturing carbon dioxide, comprising:
(a) flowing an input air stream through a dryer to thereby produce a pre-capture stream, wherein said dryer removes water from said input air stream;
(b) flowing said pre-capture stream into a capture chamber in fluid communication with said dryer, wherein a CO₂ adsorbent bed is positioned within said capture chamber;
(c) using a vacuum source to thereby decrease a pressure of said capture chamber to a blowdown pressure, thereby removing non-CO₂ components from said capture chamber as an exhaust stream; and
(d) heating said CO₂ adsorbent bed and using said vacuum source on said CO₂ adsorbent bed to thereby extract said carbon dioxide from said capture chamber to thereby produce a purified carbon-dioxide stream.

7. The method according to claim 6, wherein step (c) further comprises adding heat energy to said CO₂ adsorbent bed by way of a heater.

8. The method according to claim 7, wherein said heat energy increases a temperature of said CO₂ adsorbent bed to between about a temperature of said input air stream and about 80° C.

9. The method according to claim 6, further comprising a step of:
(e) passing a dry gas stream through said capture chamber,
wherein said dry gas is passed through said CO₂ adsorbent bed to thereby cool said CO₂ adsorbent bed and to thereby form a heated gas stream, and wherein said heated gas stream is flowed through said dryer to thereby regenerate said dryer.

10. The method according to claim 6, wherein said CO₂ adsorbent bed comprises at least one of: a zeolite adsorbent, a metal-organic framework adsorbent, a covalent-organic framework adsorbent, a silica adsorbent, or an alumina adsorbent.

11. The method according to claim 6, wherein said pressure of said capture chamber during step (c) is between 0-0.1 atm.

12. The method according to claim 6, wherein said CO₂ adsorbent bed is heated to a temperature of about 80° C. to about 275° C. during step (c).

13. The method according to claim 6, wherein said method is continuously repeated to extract said carbon dioxide from a continual source of air.

14. The method according to claim 6, wherein said vacuum source is used on said dryer to thereby regenerate said dryer.

15. The method according to claim 6, comprising a further step:
(e) passing at least part of said exhaust stream through a secondary capture chamber having a secondary CO₂ adsorbent bed,
wherein said secondary CO₂ adsorbent bed cools down using said exhaust stream creating a heated exhaust stream.

16. The method according to claim 6, wherein said exhaust stream passes through a separate dryer after being removed from said capture chamber.

17. The method according to claim 6, further comprising a step of:
(e) executing at least one of: carbonating a beverage or dispensing a drink.

18. An apparatus for capturing carbon dioxide from air, said apparatus comprising:
a first valve controlling a first opening of a major water capture bed enclosure, said first valve being configured to allow an input air stream to introduce said air into said major water capture bed enclosure when said first valve is at least partially open;
a major water capture bed positioned within said major water capture bed enclosure;
a second valve controlling a boundary between a second opening of said major water capture bed enclosure and a first opening of a capture chamber, wherein said major water capture bed enclosure and said capture chamber are in fluid communication when said second valve is at least partially open;
a CO₂ adsorbent bed positioned within said capture chamber;
a vacuum source in fluid communication with said capture chamber, wherein said vacuum source is used to create a pressure below atmospheric pressure in said capture chamber;
a heater, said heater being thermally coupled to said CO₂ adsorbent bed such that said heater provides heat to said adsorbent bed when said heater is active;
a third valve controlling a boundary between a second opening of said capture chamber and a first opening of a minor water capture bed enclosure, wherein said capture chamber and said minor water capture bed enclosure are in fluid communication when said third valve is at least partially open, and wherein said capture chamber is vacuum tight when said second valve and said third valve are closed;
a minor water capture bed positioned within said minor water capture bed enclosure; and
a fan in fluid communication with a second opening of said minor water capture bed enclosure;
wherein said apparatus performs a temperature vacuum swing adsorption cycle to thereby remove said carbon dioxide from said CO₂ adsorbent bed, and
wherein CO₂-depleted air is removed by said fan.

19. The apparatus according to claim 18, wherein said CO₂-depleted air is at least partially recycled into said input air stream.

20. The apparatus according to claim 18, wherein said vacuum source regenerates at least one of said major water capture bed and said minor water capture bed.
